(19) United States
(12) Patent Application Publication
(10) Pub. No.: US 2006/0129393 A1
(43) Pub. Date: Jun. 15, 2006

(54) System and method for synthesizing dialog-style speech using speech-act information

(75) Inventors: Seung Shin Oh, Taejon (KR); Jong Jin Kim, Jeollabuk-Do (KR); Moonok Choi, Chungcheongbuk-Do (KR); Young Jik Lee, Taejon (KR); Sanghun Kim, Taejon (KR)

Correspondence Address: MAYER, BROWN, ROWE & MAW LLP, 1909 K STREET, N.W., WASHINGTON, DC, 20006, US

(73) Assignee: ELECTRONICS AND TELECOMMUNICATIONS RESEARCH INSTITUTE

(21) Appl. No.: 11/132,310

(22) Filed: May 19, 2005

(30) Foreign Application Priority Data
Dec. 15, 2004 (KR) 2004-106610

(51) Int. Cl. G10L 19/14

(52) U.S. Cl. 704/234

(57) ABSTRACT

A system and a method for synthesizing a dialog-style speech using speech-act information are provided. According to the system and the method, tagging for discriminating an intonation is performed for expressions whose intonations need to be differently realized depending on a dialog context in a dialog text using speech-act information extracted (from the) sentences uttered by two speakers having a dialog. When a speech is synthesized, a speech signal having an intonation appropriate for the tag is extracted from a speech DB and used, so that natural and various intonations appropriate for a dialog flow can be realized. Therefore, an aspect of an interaction in a dialog can be well expressed and thus improvement of naturalness in a dialog speech can be expected.

### BACKGROUND OF THE INVENTION

1. Field of the Invention

The present invention relates to a system and a method for synthesizing a dialog-style speech using speech-act information, and more particularly, to a system and a method for synthesizing a dialog-style speech using speech-act information capable of selectively realizing different intonations for a predetermined word or a sentence in a dialog-style text using the speech-act information in a dialog-style text-to-speech system.

2. Description of the Related Art

The text-to-speech system is an apparatus for converting an input sentence into a speech audible by a human being. As illustrated in FIG. 1, a corpus-based text-to-speech system includes a preprocessing module 10, a linguistic module 20, a prosodic module 30, a unit selector 40, and a speech generator 50.

According to the related art text-to-speech system having the above-described construction, if normalization of the input sentence is performed by the preprocessing module 10, the linguistic module 20 performs a morphological analysis or a syntactic parsing for the normalized input sentence and performs a grapheme-to-phoneme conversion for the normalized input sentence.

Subsequently, if the prosodic module 30 finds out an intonational phrase to give an intonation or assign break strength to the phrase, the unit selector 40 browses synthesis units of the prosody-processed input sentence from a synthesis unit database (DB) 41, and finally the speech generator 50 connects the synthesis units browsed by the unit selector 40 to generate and output a synthesized voice.

The text-to-speech system operating in this manner performs the morphological analysis and a syntactic parsing by a sentence unit without considerations of a context or a flow of a dialog, to find out an intonational phrase and realizes a prosody by giving an intonation or assigning a phrase break to the intonational phrase. The method considering only factors within a sentence as described above is appropriate as a method for synthesizing a read-style speech but has limitations in expressing an input sentence with the assumption of an interaction between persons having a conversation each other such as a dialogue text in form of speech, for there exist many expressions of dialog-style speeches realized in different intonations depending on before and after conversation contents even though the expressions are the same.

For example, there exist words like “ne” (yes), “anio” (no), “kuroseyo” (Is it so), and “gulsse” (Let me see) in Korean. These words are used, representing different meanings with different intonations in different contexts. Among them, take a case of “ne” (yes) that is used as a response word as an example. The “ne” is realized in different intonations depending on whether the “ne” is an affirmative answer to a question of a person and or the “ne” is just an expression of recognition with respect to a preceding utterance. If a variety of intonations of the expressions is not properly expressed depending on a context or a meaning thereof, it is difficult to understand an intention of an utterance, and resultantly, naturalness of the dialog-speech might be deteriorated.

### SUMMARY OF THE INVENTION

Accordingly, the present invention is directed to a system and a method for synthesizing a dialog-style speech using speech-act information, which substantially obviates one or more problems due to limitations and disadvantages of the related art.

It is an object of the present invention to provide a system and a method for synthesizing a dialog-style speech using speech-act information capable of realizing an intonation appropriate for a meaning and a dialog context in a variety of ways by performing a tagging on the basis of rules extracted from speech-act information of the dialog context in a statistical way, i.e., a preceding or a following utterance with respect to predetermined words or sentences that have the same form and that need to be realized in different intonations depending on their meanings and by using a speech segment appropriate for the tag from a synthesis unit database (DB) when synthesizing the speech.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a system for synthesizing a dialog-style speech using speech-act information, which includes: a preprocessing module for performing a normalization of an input sentence in order to preprocess the input sentence; a linguistic module for performing a morphological tagging operation and a speech-act tagging operation for the preprocess-completed input sentence, discriminating whether a predetermined expression whose intonation should be selectively realized is included in the speech-act tagging-completed input sentence, and performing a tag operation for the predetermined expression using an intonation tagging table where intonation tags are set so as to correspond to linguistic information extracted from a dialog context including a preceding sentence and a following sentence if the predetermined expression is included in the input sentence; a prosodic module for giving an intonation; a unit selector for extracting a marked relevant speech segment appropriate for a tag with respect to the intonation-tagged expression in the prosodic-processed input sentence; and a speech generator for connecting a speech segment and another speech segment to generate and output a dialog-style synthesized speech. [0011 In another aspect of the present invention, there is provided a method for synthesizing a dialog-style speech using speech-act information, which includes the steps of: (a) performing a morphological tagging operation and a speech-act tagging operation for a preprocess-completed input sentence; (b) discriminating whether a predetermined expression whose intonation should be selectively realized is included in the speech-act tagging-completed input sentence; (c) if the predetermined expression is included in the input sentence, performing a tag operation for the predetermined expression using an intonation tagging table where intonation tags are set so as to correspond to linguistic information extracted from a dialog context including a preceding sentence and a following sentence; (d) extracting a relevant speech segment from a synthesis unit database (DB) where a speech segment appropriated for an intonation of the tagging-completed predetermined expression is marked; and (e) connecting a speech segment and another speech segment to generate a dialog-style synthesized speech.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 is a view of a text-to-speech (TTS) system;

FIG. 2 is a flowchart of a method for realizing a selective intonation for a predetermined expression within a dialog-type text using speech-act information according to the present invention;

FIG. 3 is a table exemplarily showing a dialog text;

FIG. 4 is a table exemplarily showing a speech-act tag set of a dialog-style sentence;

FIG. 5 is a table of a part of a table for speech-act tagging;

FIG. 6 is a table showing results of speech-act tagging of an exemplary dialog text;

FIG. 7 is a table showing a pair of speech-act tags of a preceding sentence and a following sentence and intonation types of“ne” corresponding thereto; and

FIG. 8 is a table showing results of intonation tagging for “ne” in an exemplary dialog text.

### DETAILED DESCRIPTION OF THE INVENTION

Reference will now be made in detail to the preferred embodiments of the present invention, examples of which are illustrated in the accompanying drawings.

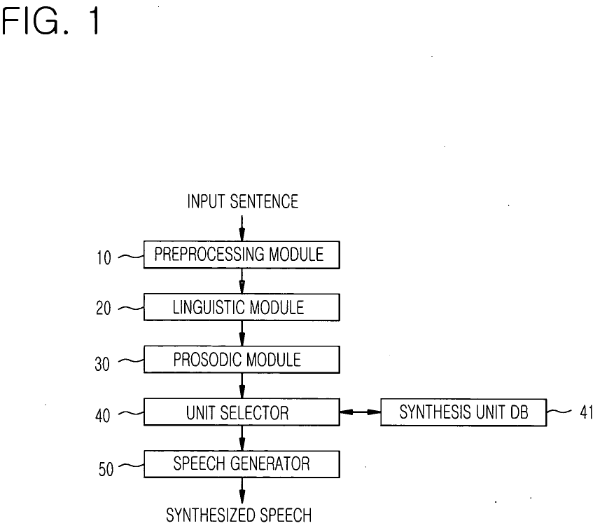

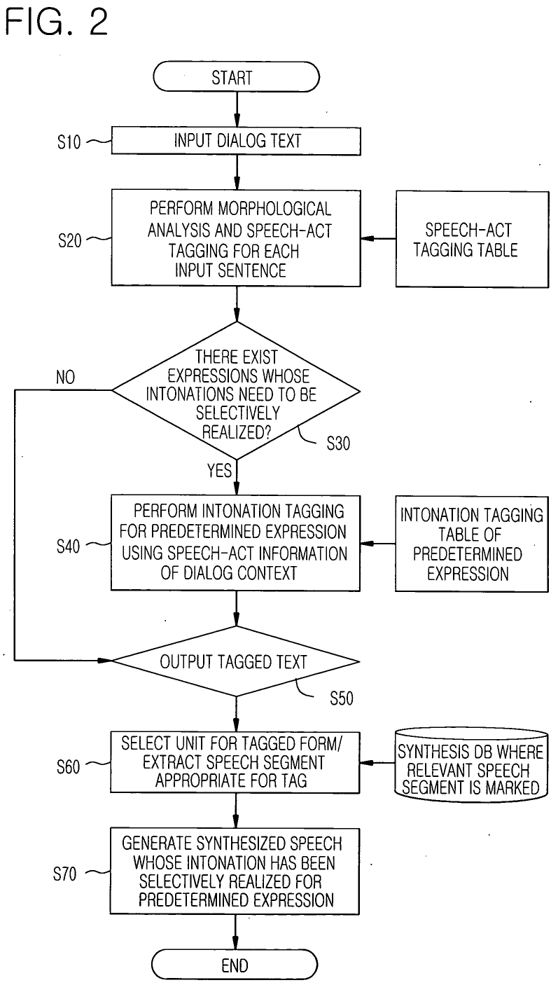

Referring to FIG. 2, a method for realizing a selective intonation for a predetermined expression within a dialog text according to the present invention is performed by a text-to-speech system as shown in FIG. 1. Particularly, a word “selective” which is used in describing the present invention has a meaning of “selecting a different intonation depending on conditions”. Here, since a corpus-based text-to-speech system of FIG. 1 is the already described, detailed description thereof is omitted and functions different from those of a related art will be described in detail through the following operations.

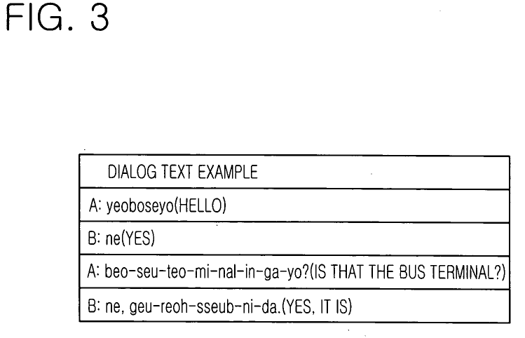

Exemplary dialog text sentences shown in FIG. 3 is intended for describing the method for realizing the selective intonation with respect to a word “ne”, represented in a telephone conversation.

The word “ne” having a different meaning repeatedly appears in the dialog text illustrated in FIG. 3. Here, the “ne” appearing first represents recognition of an utterance of a counter part and an attitude expecting an utterance of the counter part. On the contrary, the “ne” appearing second represents an affirmative answer to the question. These two “ne” are pronounced in different intonations. Generally, the first “ne” has an intonation of a rising tone but the second “ne” has an intonation of a falling tone.

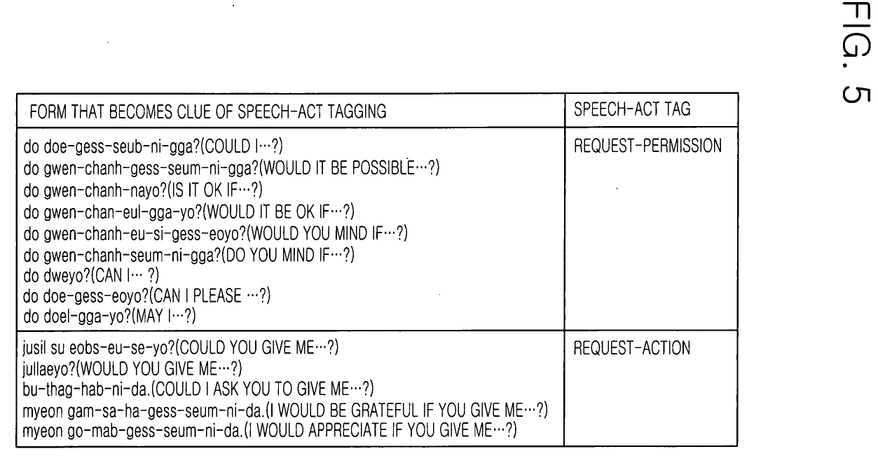

If the dialog text is inputted in a Korean text-to-speech system, the dialog-style sentences converted into Korean by the preprocessing module 10 and delivered to the linguistic module 20 (S10). The linguistic module 20 performs a speech-act tagging operation for the inputted sentences using a speech-act tagging table as illustrated in FIG. 5 (S20).

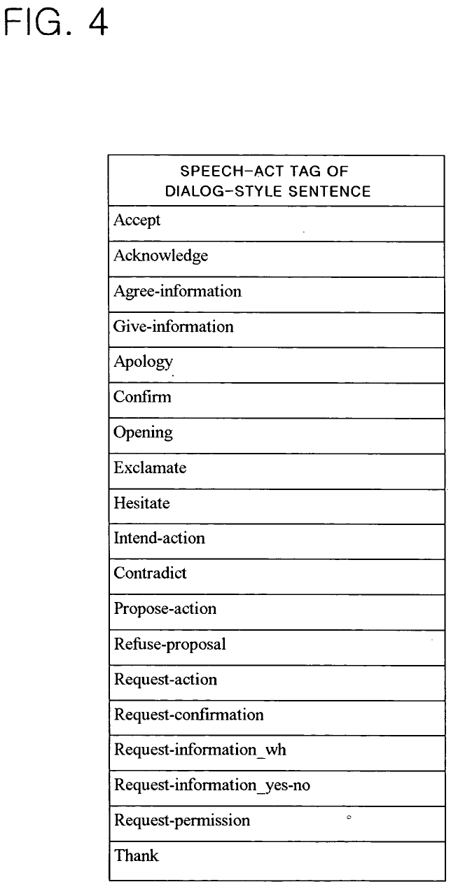

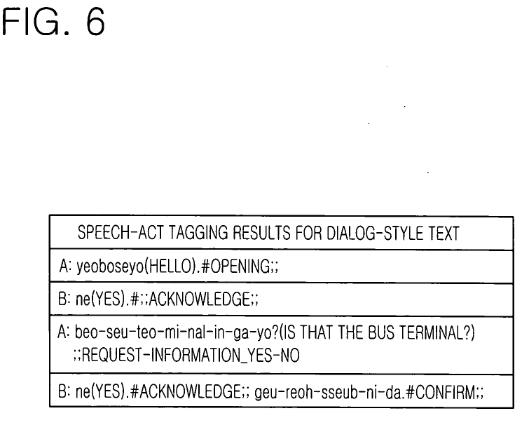

The speech-act is an element classified on the basis of an utterance intention of a speaker revealed in the back of a linguistic form, not the linguistic form itself and is now being used as an analysis unit of a dialog. For speech-act tagging, it is required first to set a speech-act tag set. The number of the kinds of the speech-act tag set can be different depending on the domain of a dialog corpus. FIG. 4 exemplarily shows the speech-act tag set. After performing a speech-act tagging operation for sentences of a dialog corpus on the basis of the tag set, a training module extracts information that provides a clue determining each speech-act from the sentence to generate a speech-act tagging table. FIG. 5 is a part of a table showing extracted form information and a speech-act tag corresponding thereto. If the input sentence has a form on the left column of the table, the sentence is tagged with a speech-act tag on the right column by a pattern matching method. FIG. 6 shows speech-act tagging results of the dialog text example.

After the speech-act tagging operation is completed, whether an expression whose intonation should be selectively realized is included in the input sentence is judged (S30).

If it is judged that such an expression is included in the input sentence, the linguistic module 20 performs an intonation tagging operation for a predetermined expression using an intonation tagging table based on the speech-act information of a preceding and a following sentence (S40).

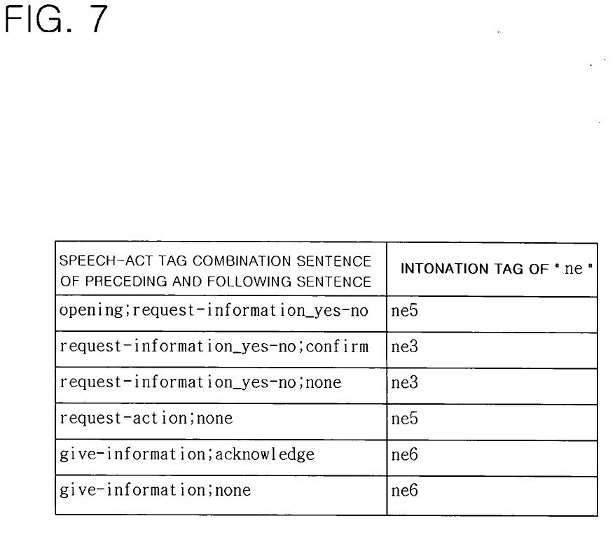

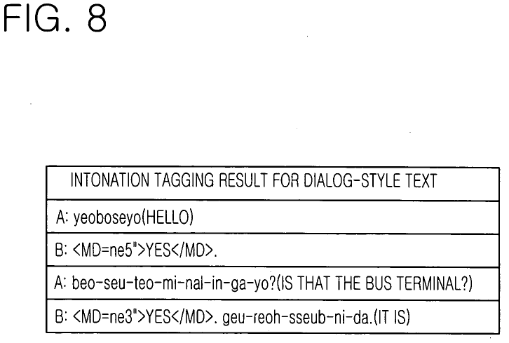

FIG. 7 shows a part of a table used in tagging a response word “ne” on the basis of speech-act tag information of a dialog-style sentence. The words “ne” that have been tagged with different intonation tags, respectively, are realized with differently determined intonations, respectively, when the speech is synthesized. The tagging table for discriminating the intonations of various types of the word “ne” is extracted from a speech-act tagged dialog corpus and a corresponding speech data. A type of the intonation of the word “ne” appearing in the dialog-style speech is set first. The “ne” is tagged to text data that corresponds to the voice data according to the kind set above. Next, a type and a frequency of a speech-act tag combination of a sentence of a counterpart speaker which is a preceding sentence and a following sentence of the word “ne” are extracted and a tagging table of the “ne” that corresponds to the speech-act tag combination is generated on the basis of the analyzed type and frequency. At this point, a “none” among the speech-act tag combinations means that there doesn't exist a following speech-act tag because a following sentence does not exist. A first “ne” in a sentence example of FIG. 8 corresponds to this case.

Tagging results for the “ne” appearing in the sentence example are shown in FIG. 8. For example, in case of a tagging result for the first “ne” in FIG. 8, a speech-act tag of a preceding sentence is “opening” and the tag after the first “ne” is none, so the tagging result becomes “ne5” that corresponds to a speech-act tag combination of an “opening” and a “none”. In case of a tagging result for a second “ne” in FIG. 8, a speech-act tag of a preceding sentence is “request-information” and a speech-act tag of a following sentence is “confirm”, so the tagging result becomes “ne3”.

The intonation tagging operation for a predetermined expression is completed by the linguistic module 20 as described above, the tagged text is sent to the unit selector 40 by way of prosodic module 30 (S50). The unit selector 40 extracts a relevant speech segment marked appropriately for the tag from the synthesis unit DB with respect to the tagged expression form (S60). Next, the speech generator 50 connects this speech segment with other speech segment to generate a dialog-style synthesized speech (S70).

The above description is a mere embodiment of performing a method applied to the Korean language, for selective realizing of intonation of a predetermined expression within a dialog-style text. Phenomenon that the same expression can be pronounced with a variety of intonations and rhythm as described above can occur in all of languages, not in only the Korean language. Therefore, the present invention can be applied to a dialog-style text-to-speech system of other languages. In English, expressions like “yes, oh really, well, right, OK, hello” are spoken with different meanings and prosodies depending on different contexts. Accordingly, the present invention is not limited to the Korean language.

As described above, the system and the method for synthesizing a dialog-style speech using speech-act information have an advantage of giving natural and various dialog-style intonations that are appropriate for a dialog flow and utterance content to an input text. Further, since the intonation realization method is performed by the rule extracted on the basis of actual data, the system and the method can be appropriately applied even though data domain is changed. Still further, the system can be applied to a dialog system having both speech recognition and speech synthesis as well as the text-to-speech system. In the dialog system, an aspect of an interaction between the human being and a computer can be expressed with more of naturalness in realizing the goal of a dialog between the human being and the computer, so that improvement of spontaneity in a dialog speech can be expected.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A system for synthesizing a dialog-style speech using speech-act information, comprising:
a preprocessing module for performing a normalization of an input sentence in order to preprocess the input sentence;
a linguistic module for performing a morphological tagging operation and a speech-act tagging operation for the preprocess-completed input sentence, discriminating whether a predetermined expression whose intonation should be selectively realized is included in the speech-act tagging-completed input sentence, and performing a tagging operation for the predetermined expression using an intonation tagging table where intonation tags are set so as to correspond to linguistic information extracted from a dialog context including a preceding sentence and a following sentence if the predetermined expression is included in the input sentence;
a prosodic module for giving an intonation;
a unit selector for extracting a marked relevant speech segment appropriate for an intonation tag of the expression in the input sentence; and
a speech generator for connecting a speech segment and another speech segment to generate and output a dialog-style synthesized speech.

2. The system of claim 1, further comprising a synthesis unit database (DB) for providing the marked relevant speech segment appropriate for the tag to the unit selector.

3. A method for synthesizing a dialog-style speech using speech-act information, wherein an intonation tagging is performed by rules extracted in a statistical way using a context information consisting of speech-act information which is an analysis unit of a dialog represented in a preceding and a following utterances for predetermined words or sentences having the same form and whose intonations need to be realized differently depending on their meaning, and an intonation appropriate for a meaning and a dialog context is realized using a speech segment appropriate for a relevant tag when a speech is synthesized.

4. A method for synthesizing a dialog-style speech using speech-act information, comprising the steps of:
(a) performing a morphological tagging operation and a speech-act tagging operation for a preprocess-completed input sentence;
(b) discriminating whether a predetermined expression whose intonation should be selectively realized is included in the speech-act tagging-completed input sentence;
(c) if the predetermined expression is included in the input sentence, performing a tagging operation for the predetermined expression using an intonation tagging table where intonation tags are set so as to correspond to linguistic information extracted from a dialog context including a preceding sentence and a following sentence;
(d) extracting a relevant speech segment from a synthesis unit database (DB) where a speech segment appropriated for an intonation of the tagging-completed predetermined expression is marked; and
(e) connecting a speech segment and another speech segment to generate a dialog-style synthesized speech.

5. The method of claim 4, wherein the step (c) comprises the steps of:
(c1) classifying intonation types of the predetermined expressions and the corresponding tags; and
(c2) performing an intonation tagging for the predetermined expression using rules or a table extracted on the basis of speech-act information obtained from a dialog context of a preceding and a following sentences of the predetermined expression or a range beyond those sentences in the input dialog text.

6. The method of claim 4, further comprising, before the step (a), the step of:
after a speech-act tagging is performed for a sentence of a dialog corpus on the basis of a speech-act tag set made for the relevant domain in advance, extracting information that becomes a clue determining each speech-act in a sentence to generate a speech-act tagging table.
